(19) United States
(12) Patent Application Publication
(10) Pub. No.: US 2011/0225287 A1
(43) Pub. Date: Sep. 15, 2011

(54) METHOD AND SYSTEM FOR DISTRIBUTED PROCESSING OF WEB TRAFFIC ANALYTICS DATA

(75) Inventors: MUKESH DALAL, Portland, OR (US); JOHN L. EASTERDAY, Beaverton, OR (US)

(73) Assignee: WEBTRENDS INC., Portland, OR (US)

(21) Appl. No.: 12/723,478

(22) Filed: Mar. 12, 2010

(51) Int. Cl. G06F 15/173

(52) U.S. Cl. 709/224

(57) ABSTRACT

A distributed analytics method and system for processing hit data and producing reports. The hit data includes attributes and values representing activities of a visitor on a web site. The distributed analytics system may include log processors to read and parse the hit data. Analytics generators are configured to read and process the parsed hit data and store the processed data in one or more analytics data stores, which are associated with bands. Analytics processors read and merge data from the analytics data stores associated with the bands, and produce intermediate report deltas. Report generators are configured to receive the intermediate report deltas and produce and store one or more report segments in report data stores. External data can be combined with the data being processed. Report processors are configured to read data from the report data stores and produce a final result based on the report segments.

### BACKGROUND OF THE INVENTION

This disclosure relates to web traffic analytics, and, more particularly, to a method and apparatus for distributed processing of web traffic analytics data.

Today, the worldwide web is perhaps the most important medium for accessing information or conducting business in the world. Web servers interconnected via the Internet are becoming prolific and provide access to a variety of content for a wide array of businesses and individuals. The relative ease of creating web sites tends to have a multiplying effect on the sheer number of web sites. The quality and usability of web sites is also constantly improving. Access to such web sites is readily facilitated via the Internet for all types of web site visitors from nearly all parts of the world.

The expansive growth of the Internet has created opportunities for new online businesses to be formed such as retail establishments, business-to-business facilitators, news sites, blogs, social networks, among many others. In addition, traditional brick-and-mortar businesses are rapidly changing from the “old” ways of doing business to the more modern, “online” way of doing business. By quickly adapting to the changing technology landscape, particularly in the area of e-commerce, businesses can gain a competitive advantage.

By its very nature, the Internet provides an interactive experience between the web site visitor and the web server. The web server can gather information about each visitor by observing and logging the web traffic data exchanged between the web server and the visitor. Important details about the visitors and their visits to web sites can be determined by analyzing the web traffic data and the context of the “hit.” Further, web traffic data collected over a period of time can yield statistical information, otherwise know as web traffic “analytics” data, such as the number of visitors visiting the site each day, demographic information, or frequency of returning visitors, etc. Such web traffic analytics data is useful in tailoring marketing or other strategies to better match the needs of the visitors.

However, as the number of web site visitors increases for a given web server or group of related web servers, the computational and storage requirements for generating and storing the web traffic analytics data and any associated reports significantly increase as well. This can cause delays in processing, data bottlenecks, web server down time, and other serious challenges. It is also difficult to expand or reduce processing capability or storage capacity of the web traffic analytics data to reflect the changing needs of a given web server or group of related web servers.

Accordingly, there remains a need for a way to improve the processing and storage of web traffic analytics data, and the generation of associated reports based on such data.

It would be desirable to distribute the processing of the web traffic analytics data and to provide dynamic expansion or reduction of the processing capability or storage capacity of the web traffic analytics data.

It would also be desirable to provide a scalable analytics system having low latency from input to output, and deployable in a low cost, flexible, and configurable manner.

### BRIEF DESCRIPTION OF THE DRAWINGS

FIG. 1 shows a block diagram of various components for performing distributed processing of web traffic analytics data according to an example embodiment of the invention.

FIG. 2 shows another example embodiment similar to the components of FIG. 1, additionally including log data store(s), log processor(s), and an N-way cross connect.

FIG. 3 illustrates additional aspects of the log data store(s) of FIG. 2.

FIG. 4 illustrates an alternative arrangement of inputs to the log data store(s) of FIG. 2.

FIG. 5 illustrates additional aspects of the log processor(s) of FIG. 2.

FIG. 6 shows a block diagram including some of the components as illustrated in FIG. 1, including additional details about the distributed processing aspects of the components.

FIG. 7 shows a block diagram including the report processor(s) of FIG. 6 in further relation to the data consumer(s) according to another example embodiment of the invention.

FIG. 8 shows a block diagram including an alternative embodiment of the report data store(s) of FIG. 6, and associated therewith master report processor(s) and slave report processor(s).

FIGS. 9 and 9A show a flow diagram for receiving, storing, and processing analytics data according to an example embodiment of the invention.

FIG. 10 shows a flow diagram for receiving, storing, and processing analytics data according to another example embodiment of the invention.

FIG. 11 shows a flow diagram for configuring and processing master report processor(s) and slave report processor(s) for simultaneously processing portions of a final result.

FIG. 12 shows a flow diagram for configuring first and second bands, and processing web traffic analytics data using the first and second bands.

### DETAILED DESCRIPTION OF THE PREFERRED EMBODIMENT

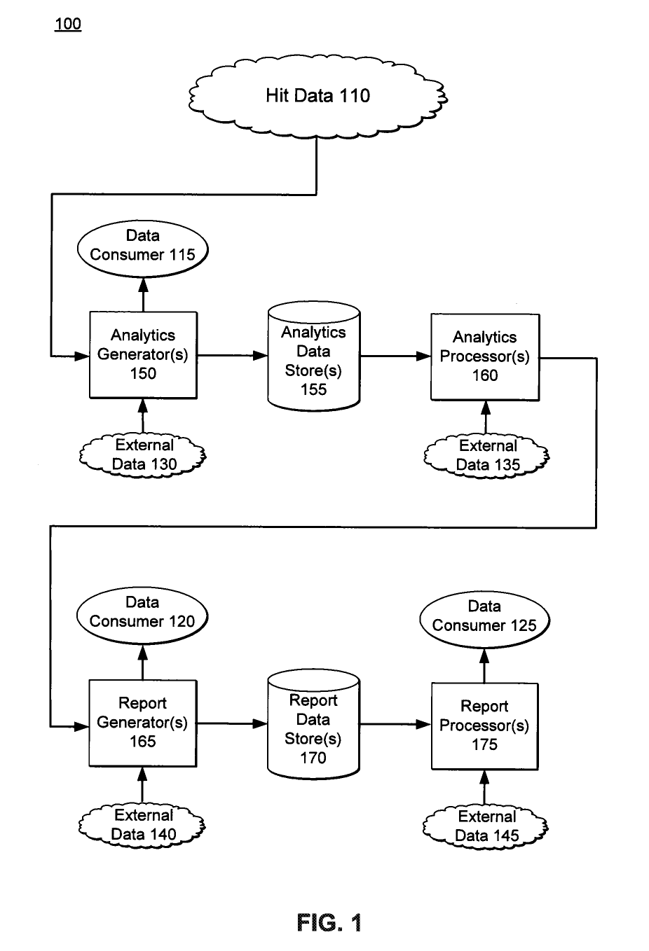

FIG. 1 shows a block diagram of various components for performing distributed processing of web traffic analytics data according to an example embodiment of the invention. A distributed system for analytics can include one or more analytics generator instances, for example analytics generator(s) 150, which can receive and process hit data 110. The hit data 110 may be available periodically or continuously, and can include, for example, data commonly referred to as “clickstream” data corresponding to visitor clicks while visiting a web site. Moreover, the hit data 110 can include one or more hits. Each hit can include attributes and values representing activities of an individual such as a visitor on a web site. For example, each hit can include a time value, a visitor identification (ID), a visit identification (ID), a web page identification (ID), among other possibilities. The time value can include the data and/or time. The visitor ID is an identifier of the visitor to a web site. The visit ID is an identifier of a visit by a visitor to a web site. The web page ID is an identifier of a web page of a web site. Persons with skill in the art will recognize that hit data 110 can include other types of data besides those mentioned herein.

The analytics generator(s) 150 can process the hit data 110 and store the results in one or more analytics data store instances, such as analytics data store(s) 155, and/or merge the processed hit data 110 with historical data existing in the analytics data store(s) 155, as will be further discussed in detail below. All of the analytics generator(s) 150 can be configured to operate on a single computer web server or computer system; alternatively, each of the analytics generator(s) 150 can be associated with one computer server or computer system, or groups of analytics generators can be associated with different computer servers or computer systems. If a computer server has multiple processor cores, one or more analytics generators can be associated with a corresponding one of the processor cores. The term “computer server,” “computer web server,” and “web server” are used interchangeably herein.

The analytics generator(s) 150 can comprise computer hardware, an integrated circuit such as an Application-Specific Integrated Circuit (ASIC), software, firmware, or any combination thereof The analytics data store(s) 155 can include, for example, magnetic disk storage, non-volatile memory, volatile memory, or other suitable storage device(s) or systems such as a Local Area Network (LAN), a Storage Area Network (SAN), a Wide Area Network (WAN), etc., any of which may be coupled to the computer server or computer system associated with the analytics generator(s) 150, and any of which may persistently or temporarily store the processed hit data 110 in the form of a file, compressed file, as text, as binary, or in a database, among other possibilities. In some embodiments, the analytics data store(s) 155 may be omitted and the data instead processed in real-time.

In addition to storing the hit data 110 in the analytics data store(s) 155, the analytics generator(s) 150 can process and output the hit data 110 to a data consumer 115, either periodically or continuously. The data consumer 115 can be any external system or end-user. For example, the data consumer 115 is operable with a computer server, a computer system, an integrated circuit such as an ASIC, software, firmware, or any combination thereof The data consumer 115 can also be an individual (i.e., person).

Optionally, external data 130 can be periodically or continuously combined with the hit data 110 before or after storing the processed hit data in the analytics data store(s) 155. The external data 130 can include, for example, a money exchange rate so that if the hit data 110 includes information based on a particular country's currency, the external data 130 can be combined with such information and used to generate similar information, but based on a different country's currency. Further, the external data 130 can include, for example, phone call interaction data or recordings generated when an individual or visitor to a web site calls a web site operator or support representative. Another example of the external data 130 is retail point-of-sale information of an e-commerce related web site.

The external data 130 may also include, for example, translation data for mapping a product ID included in the hit data 110 to a product name. Persons with skill in the art will recognize that other types of translation data for mapping one set of data to another set of data, although not specifically mentioned herein, can be included in the external data 130.

The external data 130 can be input and combined with the hit data 110 at about the time of storing the hit data 130 in the analytics data store(s) 155. Accordingly, the external data 130 can be used by the analytics generator(s) 150 or by downstream components such as the analytics processor(s) 160, the report generator(s) 165, the report data store(s) 170, and the report processor(s) 175.

Data from the analytics data store(s) 155 can then be processed by one or more analytics processor instances, such as analytics processor(s) 160, to produce intermediate results (not shown), as will be discussed in detail below. All of the analytics processor(s) 160 can be configured to operate on a single computer server or computer system, which can be the same computer server or computer system associated with analytics generator(s) 150 and/or the analytics data store(s) 155, although this need not be the case; alternatively, each of the analytics processor(s) 160 can be associated with one computer server or computer system, or groups of analytics processors can be associated with different computer servers or computer systems. If a computer server has multiple processor cores, one or more analytics processors can be associated with a corresponding one of the processor cores. The analytics processor(s) 160 can comprise computer hardware, an integrated circuit such as an Application-Specific Integrated Circuit (ASIC), software, firmware, or any combination thereof

At about the time of processing the data from the analytics data store(s) 155, the analytics processor(s) 160 can receive external data 135, which can optionally be combined with data from the analytics data store(s) 155, either periodically or continuously. The external data 135 can include, for example, any of the information mentioned above with reference to external data 130. The external data 135 can be input and combined with the data from the analytics data store(s) 155 or intermediate results at about the time of transmitting the intermediate results to one or more report generator instances, such as report generator(s) 165. Accordingly, the external data 135 can be used by the analytics processor(s) 160 or by downstream components such as the report generator(s) 165, the report data store(s) 170, and the report processor(s) 175.

The intermediate results received from the analytics processor(s) 160 can be merged, processed, and/or partitioned into report segment(s) by the report generator(s) 165. The report segments (not shown) are discussed in more detail below. The report generator(s) 165 can merge and store the report data with existing report data, i.e., report segment(s), stored in one or more report data store instances, such as report data store(s) 170. All of the report generator(s) 165 can be configured to operate on a single computer server or computer system; alternatively, each of the report generator(s) 165 can be associated with one computer server or computer system, or groups of report generators can be associated with different computer servers or computer systems. If a computer server has multiple processor cores, one or more report generators can be associated with a corresponding one of the processor cores. The report generator(s) 165 can comprise computer hardware, an integrated circuit such as an Application-Specific Integrated Circuit (ASIC), software, firmware, or any combination thereof.

The report data store(s) 170 can include, for example, magnetic disk storage, non-volatile memory, volatile memory, or other suitable storage device(s) or systems such as a Local Area Network (LAN), a Storage Area Network (SAN), a Wide Area Network (WAN), etc., any of which may be coupled to the computer server or computer system associated with the report generator(s) 165, and any of which may persistently or temporarily store the report segment(s) in the form of a file, compressed file, as text, as binary, or in a database, among other possibilities. In some embodiments, the report data store(s) 170 may be omitted and the data instead processed in real-time.

In addition to storing the report segment(s) in the report data store(s) 170, the report generator(s) 165 can output the report segment(s) to a data consumer 120, either periodically or continuously. The data consumer 120 can be any external system or end-user. For example, the data consumer 120 is operable with a computer server, a computer system, an integrated circuit such as an ASIC, software, firmware, or any combination thereof. The data consumer 120 can also be an individual (i.e., person).

Optionally, external data 140 can be combined with the processed data from the analytics processor(s) 160 or the report segment(s) generated by the report generator(s) 165, either periodically or continuously, and can be subsequently stored in the report data store(s) 170. The external data 140 can include, for example, any of the information mentioned above with reference to external data 130. Accordingly, the external data 140 can be used by the report generator(s) 165 or by downstream components such as the report data store(s) 170 and the report processor(s) 175.

The report segment(s) can be stored in a sorted pattern in the report data store(s) 170 by dimensional value, such as geographical location or date/time of visit, etc., to allow for distributed top N determination and reduced merge time. Top N determinations are generally based on some criteria, such as a particular date range or time period. Such top N determinations can include, for example, the top N products that have been reviewed or purchased by individuals or visitors to a web site, the top N pages of a web site visited within a given time period, among many other possibilities. Moreover, data from the intermediate results can be added to existing report segments, or rows associated with the report segments, where the dimensional values match. Both the intermediate results and the report segments can be sorted by dimension value for improving efficiency and merge time, and for improving the performance of the report processor(s) 175. Each report segment can correspond to a particular time period, such as a year, month, day, or hour, among other possibilities.

Report segment(s) from the report data store(s) 170 can then be processed by one or more report processor instances, such as report processor(s) 175 to produce one or more final result(s). In producing the final result(s), the report processor(s) 175 can merge, sort, filter, or otherwise transform the report segment(s). The report processor(s) 175 can also generate top N determinations. The report processor(s) 175 can categorize the data and/or report on other dimensional data such as geographical information, most popular web pages visited, time spent by an individual or visitor at a particular web page, products purchased, etc. For example, the report processor(s) 175 can generate the final result(s) based on geographical information such as the country, state, or city in which individuals or visitors are located.

The total number of report processor(s) 175 can be manually or automatically configured to accommodate the various possible report sizes, processing loads and usage levels, as will be discussed in further detail below. All of the report processor(s) 175 can be configured to operate on a single computer server or computer system, which can be the same computer server or computer system associated with report generator(s) 165 and/or the report data store(s) 170, although this need not be the case; alternatively, each of the report processor(s) 175 can be associated with one computer server or computer system, or groups of report processors can be associated with different computer servers or computer systems. If a computer server has multiple processor cores, one or more report processors can be associated with a corresponding one of the processor cores. The report processor(s) 175 can comprise computer hardware, an integrated circuit such as an Application-Specific Integrated Circuit (ASIC), software, firmware, or any combination thereof.

The report processor(s) 175 can output the final result(s) to a data consumer 125 either periodically or continuously. As will later be described in detail, the final result(s) can include multiple portions or multiple streams of data transmitted to the data consumer 125 in parallel, or otherwise simultaneously transmitted. Alternatively, a single final result such as a merged or combined final report can be transmitted to the data consumer 125. The data consumer 125 can be any external system or end-user. For example, the data consumer 125 can comprise a computer server, a computer system, an integrated circuit such as an ASIC, software, firmware, or any combination thereof. The data consumer 125 can also be an individual (i.e., person).

At about the time of processing the report segment(s) from the report data store(s) 170, the report processor(s) 175 can receive external data 145, which can optionally be combined with report segment(s) from the report data store(s) 170, either periodically or continuously. The external data 145 can include, for example, any of the information mentioned above with reference to external data 130. The external data 145 can be input and combined with either the report segment(s) from the report data store(s) 170 or the subsequently processed final result. Accordingly, the external data 145 can be used at a late stage of processing, i.e., at about the time of producing the final result.

An advanced distributed analytics system is therefore scalable to manage large amounts of data such as hit data, intermediate results data, analytics data, and report data, etc., which can be pipelined and simultaneously processed. Moreover, the distributed analytics system is scalable to provide output data to a large number of data consumers. The distributed analytics system also provides low-latency from input to output, can be deployed on readily available computer hardware, is low cost, configurable, and can manage and process large volumes of analytics data.

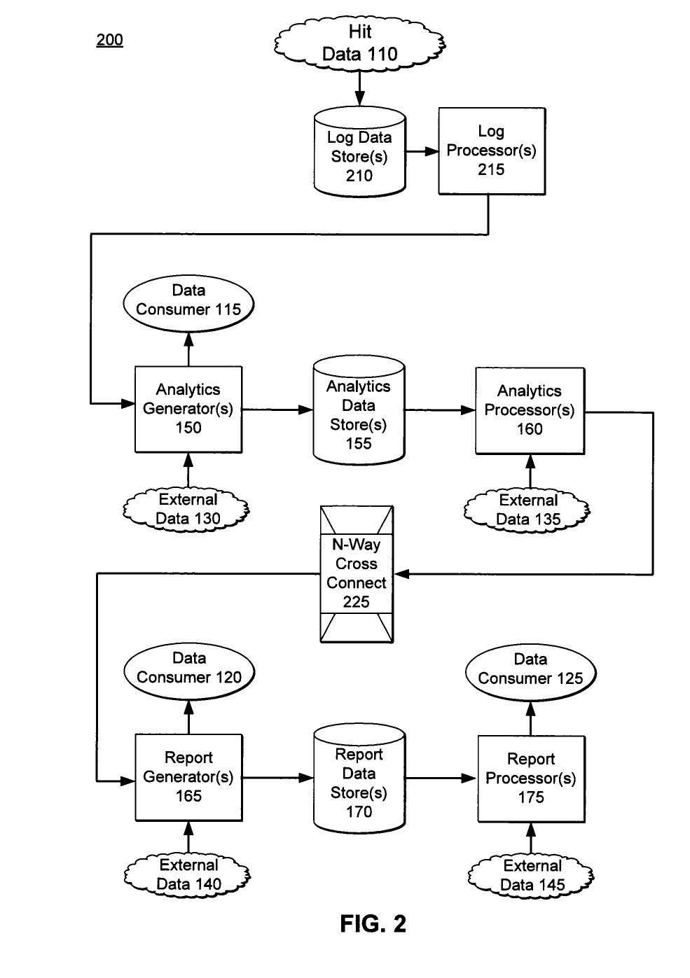

FIG. 2 shows another example embodiment similar to the components of FIG. 1, additionally including one or more log data store instances, such as log data store(s) 210, one or more log processor instances, such as log processor(s) 215, and an N-way cross connect 225. Details of the other optional components, such as the analytics generator(s) 150, analytics data store(s) 155, analytics processor(s) 160, report generator(s) 165, report data store(s) 170, and report processor(s) 175 are discussed elsewhere in this disclosure, and for the sake of brevity, need not be repeated.

Log data store(s) 210 can receive and store the hit data 110. The log data store(s) can include, for example, magnetic disk storage, non-volatile memory, volatile memory, or other suitable storage device(s) or systems such as a Local Area Network (LAN), Storage Area Network (SAN), Wide Area Network (WAN), etc., any of which may persistently or temporarily store the hit data 110 in the form of a file, compressed file, as text, as binary, or in a database, among other possibilities. As previously mentioned, the hit data 110 can include one or more hits each including attributes and values representing activities of an individual or visitor on a web site.

Log processor(s) 215 can examine the hit data 110 and parse a visitor identification (ID) and associated event attributes from the hit data 110. The parsed data can then be transmitted to the analytics generator(s) 150. Input to the log processor(s) 215 can be one or more partitions from the log data store(s) 210, or other data associated with the logged hit data 110, and can vary based on data volumes and loading factors.

The N-Way cross connect 225 provides a means for passing data from N entities, such as files, associated with the analytics processor(s) 160 to M entities associated with the report generator(s) 165. For example, intermediate results generated by the analytics processor(s) 160 can be stored in a group of N files, which can be processed by a group of M report generator(s) 165. Although the N-Way cross connect 225 is shown as a separate block in FIG. 2, it should be understood that the block represents a function performed between the report generator(s) 165 and the analytics processor(s) 160, the function of which can be implemented using a file system, database, software, hardware, or firmware, or any combination thereof. As illustrated, external data can be inputted before the N-Way cross connect 225 such as with external data 130 or 135. Alternatively, or in addition to, external data can be inputted after the N-Way cross connect 225 such as with external data 140 or 145.

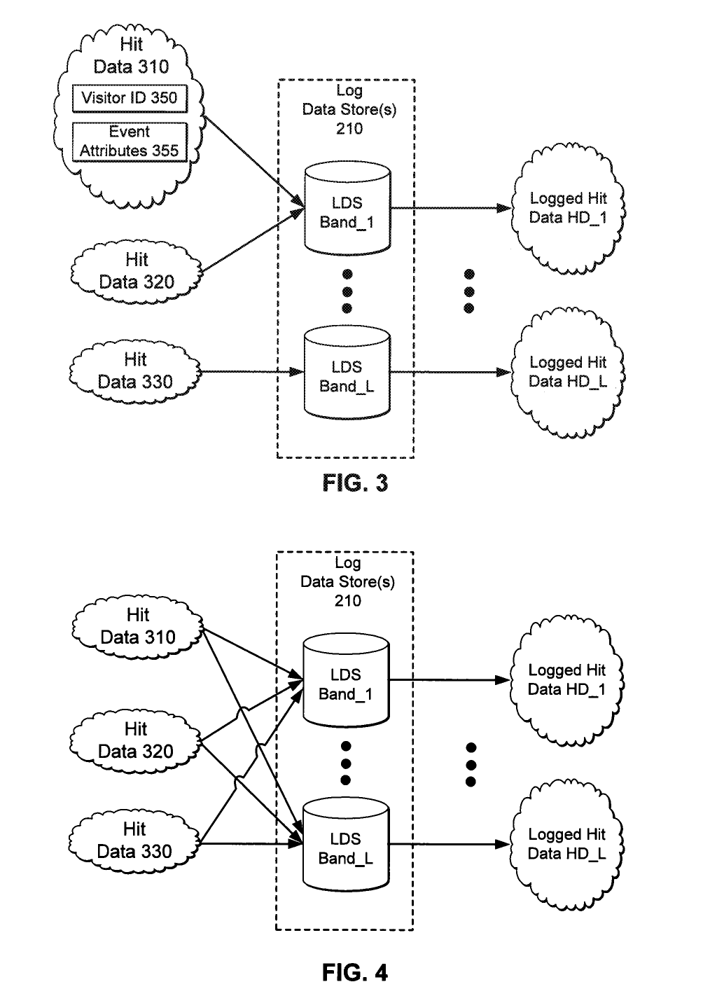

FIG. 3 illustrates additional aspects of the log data store(s) 210 of FIG. 2. As illustrated in FIG. 3, hit data can originate from more than one source, and be associated or otherwise stored in different log data store(s), or LDS(s), associated with different bands, such as Band_1 through Band_L. As used herein, the term “band” is essentially a storage partition and/or associated processing of a predefined group of data based on predefined criteria. In other words, a range of data can be assigned to a given band, and any mechanism can be used to separate the data among the bands; preferably, a partition key is used to determine which band receives which data. The partition key is preferably a hash function or modulo of a visitor ID. More than one band can be associated with essentially the same predefined group of data based on essentially the same predefined criteria. For example, hit data 310, 320, and/or 330 can be partitioned into one or more bands, such as Band_1 through Band_L, and stored in the log data store(s) 210. Typically, although not required, one band will be associated with one computer server. Alternatively, more than one band can be associated with one computer server, although there is some overhead in managing more than one band on a single computer server. Preferably, each of Band_1 through Band_L contains a predefined group of data based on their own predefined criteria.

The partitioning of the hit data can be based, for example, on a partition key, preferably a hash function or modulo of a visitor identification (ID), such as visitor ID 350. The visitor ID 350 can be parsed from the hit data. Any of the hit data, for example, hit data 310, 320, and 330 can include event attributes 355, and/or different visitor IDs, among other types of data. The partitioning function can include, for example, a hash or modulo operation based on the visitor ID 350. For example, if there are L bands, the assigned band for a particular individual or visitor can be determined by performing the function of visitor ID modulo L. Further, the partitioning of the hit data can be based, for example, on a geographic determination so that all individuals or visitors from one location (e.g., country, state, city, etc.) are associated with Band_1, and all individuals or visitors from another different location are associated with another band, i.e., selected from Band_1 through Band_L. It should be understood that other suitable deterministic functions can be used to associate hit data and/or visitors with different bands.

As is also illustrated in FIG. 3, the hit data can be explicitly split between the various bands. In other words, all of the hit data from one source, such as hit data 310, can be associated with one band, such as Band_1. For example, hit data 310 and hit data 320 can be explicitly associated with Band_1, and hit data 330 can be explicitly associated with Band_L. The log data store(s) 210 can output logged hit data HD_1 through HD_L corresponding to Band_1 through Band_L, respectively.

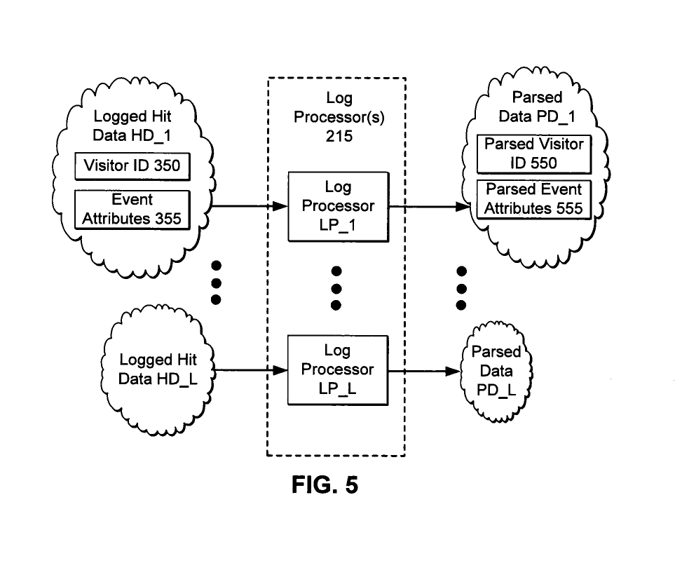

FIG. 4 illustrates an alternative arrangement of inputs to the log data store(s) of 210 FIG. 2. Although similar to FIG. 3, here the hit data 310, 320, and 330 can be implicitly split between the various bands. In other words, a filter file or some other splitting means can be used to divvy up the hit data among the bands. For example, a portion of the individuals or visitors associated with the hit data 310 can be associated with Band_1 and another portion of the individuals or visitors associated with the hit data 310 can be associated with another band, i.e., selected from Band_1 through Band_L. Similarly, hit data 320 and 330 can also be divvied up among Band_1 through Band_L. As previously mentioned, the log data store(s) 210 can output logged hit data HD_1 through HD_L corresponding to Band_1 through Band_L, respectively.

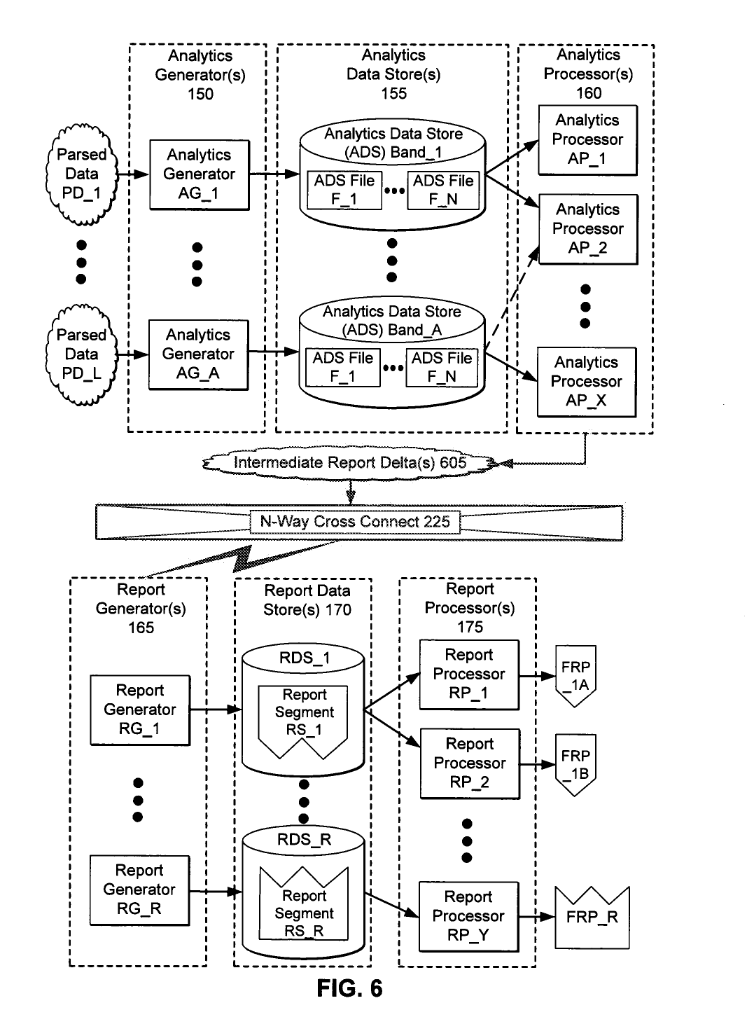

FIG. 5 illustrates additional aspects of the optional log processor(s) of 215 of FIG. 2. The log processor(s) 215 can examine each hit within the bands, e.g., Bands_1 through Band_L, and further parse or process a visitor ID, such as visitor ID 350 of FIG. 3, and associated event attributes, such as event attributes 355 from the logged hit data. Any of the logged hit data HD_1 through HD_L can include visitor IDs and event attributes, among other suitable data. The log processor LP_1 can examine, parse, or otherwise process information from logged hit data HD_1 and log processor LP_L can examine, parse, or otherwise process information from logged hit data HD_L, and so forth. At any given time, data associated with a given individual or visitor is assigned to one log processor, but can be moved to another log processor based on system load, or other processing rules. Moreover, each log processor can be responsible, or in other words, parse or process data associated with one of the bands. The log processor(s) 215 can output parsed data PD_1 through PD_L corresponding to Band_1 through Band_L, respectively. Any of the groups of parsed data, such as parsed data PD_1, can include parsed data for one or more individuals or visitors. The parsed data can include, for example, parsed visitor ID information, such as parsed visitor ID 550, and parsed event attributes, such as parsed event attributes 555.

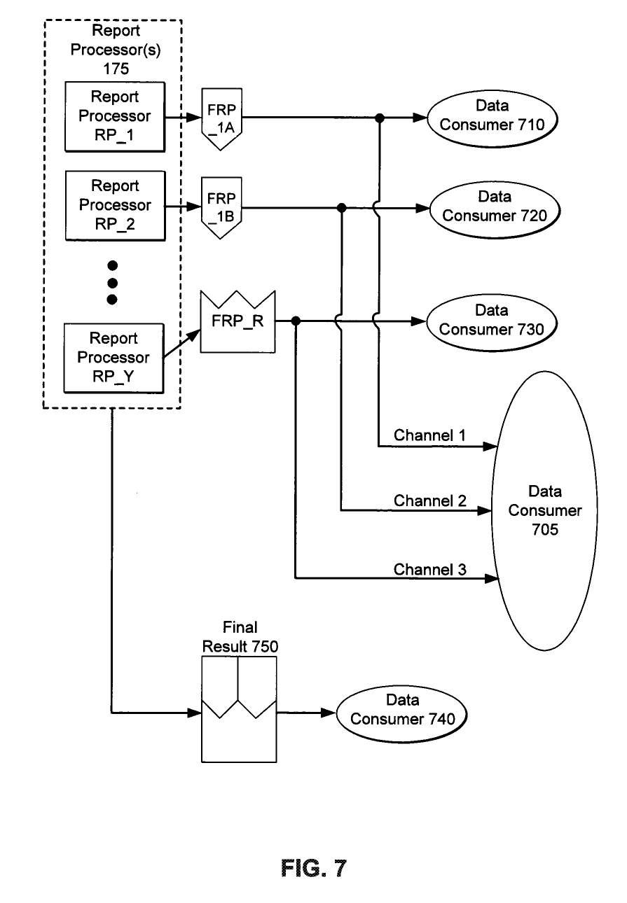

FIG. 6 shows a block diagram including some of the components as illustrated in FIG. 1, including additional details about the distributed processing aspects of the components. In some embodiments, the distributed analytics system can have at least two levels of distributed processing. For example, in one level, as described above with reference to FIGS. 1-2, the processing is pipelined. In other embodiment, the processing is not only pipelined, but in addition, the distributed processing can be further achieved by partitioning the storage and processing of data into bands, as illustrated, for example, in FIGS. 3-6.

As illustrated in FIG. 6, analytics generators 150 such as analytics generators AG_1 through AG_A, can receive and process parsed data PD_1 through PD_L, and store the results in analytics data stores 155 associated with, for example, Band_1 through Band_A. Each analytics generator 150 may be associated with a corresponding one analytics data store (ADS) and band. For example, AG_1 is associated with ADS Band_1, AG_A is associated with ADS Band_A, and so forth. Alternatively, although FIG. 6 shows separate and distinct analytics data store(s) 155 where each store is associated with a corresponding one of the bands Band_1 through Band_A—should be understood that in an alternative embodiment, a single physical analytics data store 155 includes all of the bands Band_1 through Band_A.

Moreover, each analytics generator 150 can merge the parsed data with historical data existing in, for example, one or more ADS files F_1 through F_N in a corresponding band, and/or generate one or more new ADS files. For example, AG_1 can receive and process parsed data PD_1, which can include parsed data for one or more individuals or visitors. AG_1 can merge the parsed data with historical data existing in ADS file F_1 in Band_1, and/or generate one or more new ADS files in Band_1. A history parameter (not shown) can be configured to a predefined value, for example 60 days, so that at least 60 days of historical data is preserved for a given analytics data store. A filter can be used to filter portions of the historical data.

L need not be equal to A. In other words, although preferably the number of bands A associated with the analytics data stores 155 can directly correspond to, or otherwise equal, the number of bands L associated with the log data stores 210 of FIGS. 3-4, such need not be the case. L and A may be equal or different from each other. This allows the distributed analytics system to adapt to a wide range of data volumes and processing loads.

Each analytics generator 150 can generate analytics data store files, such as ADS file F_1 through F_N. Although the term “file” is used herein, such term is not limited to only a file in the traditional sense, but can also refer to compressed data, textual data, binary data, or a database, among other possibilities. Each ADS file can include web-traffic information (e.g., parsed hit data) corresponding to a predefined period of time. The predefined period of time can be, for example, fifteen minutes, one-half hour, one whole hour, or any other suitable period of time. For example, an ADS file corresponding to Jun. 7, 2009 from 10 A.M. to 10:15 A.M. can include web-traffic information for every event of all visitors within a given band between two time points (i.e., 10 A.M. and 10:15 A.M.). Relating to the procession of time, new ADS files are generated by the analytics generators 150, proceeding, for example, from ADS file F_1 to F_2 (not shown) and ultimately to F_N for a given analytics data store and band.

As previously described, the hit data such as hit data 310, 320, and 330 (of FIGS. 3-4) can be partitioned based on a function of a visitor ID parsed from the hit data. If L is equal to A, then the previously parsed data PD_1 through PD_L can be directly associated with the bands Band_1 through Band_A. Otherwise, if L does not equal A, then the previously parsed data PD_1 through PD_L can be partitioned into the analytics data stores 155 associated with Band_1 through Band_A based on a similar, or different, partitioning function as previously described. For example, the function can include a modulo operation based on the parsed visitor ID 550, or alternatively based on geographical location, or both, among other possibilities. For example, where the function is the modulo operation, and the number of bands is A, the assigned band for a particular individual or visitor can be determined by performing the function of visitor ID modulo A. It is contemplated that functions based on information or calculations other than the modulo operation or geographical location can also be used. Once a band to which a particular individual or visitor will be assigned is selected, the parsed data corresponding to the visitor can be included in an ADS file, such as ADS file F_1, associated with the band, such as Band_.

Different analytics generators can process event data associated with different individuals or web site visitors. For example, AG_1 can process event data associated with a first web site visitor read from the parsed data PD_1, and AG_A can process event data associated with a second web site visitor read from the parsed data PD_L. AG_1 may read and/or merge historical event data from a recent historical ADS file associated with the first visitor, such as ADS file F_1 of Band_1, and/or generate a new ADS file stored in Band_1 including at least some of the associated event data and historical event data. AG_A may read and/or merge historical event data from a recent historical ADS file associated with the first visitor, such as ADS file F_1 of Band_A, and/or generate a new ADS file stored in Band_A including at least some of the associated event data and historical event data.

Analytics processors 160 can be configured so that each of the bands, such as Band_1 through Band_A, is associated with one or more of the analytics processors, such as AP_1 through AP_X. More than one analytics processor can be associated with a single analytics data store and band. The number of analytics processors X need not be equal to the number of bands A, and preferably, X is greater than A. The analytics processors can be dynamically or automatically assigned to process information from the bands. For example, AP_1 and AP_2 can be associated with ADS Band_1, and AP_X can be associated with ADS Band_A. These associations can be dynamically and automatically adjusted based on the processing load of the distributed analytics system. Each of the analytics processors, such as AP_1 and AP_2, can read and merge data from one or more analytics data store files, such as F_1 through F_N, associated with an analytics data store and band, such as ADS Band_1. In an alternative embodiment, an analytics processor, such as AP_2, is associated with and/or can read from more than one band, such as Band_1 and Band_A, as indicated by the dashed arrow. In other words, any analytics processor can read from any ADS file associated with any band. In this manner, the analytics processors 160 can efficiently process data from the analytics data stores 155.

The analytics processors can produce one or more intermediate report deltas 605 based on one or more analytics data file. More specifically, the analytics processors can maintain counts (not shown) corresponding to a frequency of detection of different hit data or event attributes stored in the analytics data files, such as analytics data store files F_1 through F_N of Band_1. For example, a hit-counter can be incremented when the analytics processor detects a web page identification (ID); a visit-counter can be incremented when the analytics processor detects a web page ID and the visit ID corresponds to a new visit; and a visitor-counter can be incremented when the analytics processor detects a web page ID and the visitor ID corresponds to a new visitor. These counts are updated for each of a group of predefined time periods. For example, the counts can be updated for a given hour, day, week, month, quarter, or year, among other possibilities. The count data can then be partitioned or merged into one or more intermediate report deltas 605. The intermediate report deltas 605 can also include dimensional data such as, for example, geographical location information of the individual or visitor, or other dimensional data about the visitor or the visitor's actions while visiting a web site.

The N-Way cross connect 225 provides a means for passing data from N entities, such as files, associated with the analytics processor(s) 160 to R entities associated with the report generator(s) 165. For example, the intermediate report deltas 605 generated by the analytics processor(s) 160 can be stored in a group of N files, which can be processed by a group of R report generator(s) 165. In other words, a number of analytics processors X need not be equal to a number of report generators R. As a result, the N-Way cross connect 225 provides a means for passing the intermediate report deltas 605 output from up to X number of analytics processors so that up to R number of report generators, such as RG_1 through RG_R, can receive and process the intermediate report deltas 605. Although the N-Way cross connect 225 is shown as a separate block in FIG. 2, it should be understood that the block represents a function performed between the report generator(s) 165 and the analytics processor(s) 160, the function of which can be implemented using a file system, database, software, hardware, or firmware, or any combination thereof.

The report generators 165, such as RG_1 through RG_R, can receive the intermediate report deltas 605 from the analytics processors 160, such as AP_1 through AP_X, via the N-way cross connect 225. The report generators 165 can merge data from the intermediate report deltas 605 into one or more report segments, such as RS_1 through RS_R. The report generators 165 store the report segments in corresponding one or more report data stores, such as RDS_1 through RDS_R. Although FIG. 6 shows separate and distinct report data store(s) 170 where each store is associated with a corresponding one of the report segments RS_1 through RS_R—it should be understood that in an alternative embodiment, a single physical report data store 170 includes all of the report segments RS_1 through RS_R.

Data from the intermediate report deltas 605 can be added to existing report segments, such as RS_1 through RS_R, or rows associated with the report segments, where the dimensional values match. Both the intermediate report deltas 605 and the report segments, such as RS_1 through RS_R, can be sorted by dimension value for improving efficiency and merge time, and for improving the performance of the report processor(s) 175. Each report segment can correspond to a particular time period, such as a year, month, day, or hour, among other possibilities.

Each report generator 165 can further process the counts which are part of the intermediate report deltas 605. For example, the report generators 165 can perform summing operations on the hit-counter values, the visit-counter values, or the visitor-counter values, for each page ID for each predefined time period, such as an hour, day, week, month, quarter, or year, etc.

Report processors 175, such as RP_1 and RP_Y, can each be configured to read data from one report data store, such as one of RDS_1 through RDS_R. More than one report processor, such as RP_1 and RP_2 can be associated with a single report data store, such as RDS_1. The number of report processors Y need not be equal to the number of report data stores R, and preferably, Y is greater than R. The report processors can be dynamically or automatically assigned to process information from the report data stores. Alternatively, a single report processor, such as RP_Y, can be associated with a single report data store, such as RDS_R. In this manner, the report processors 175 can efficiently process data from the report data stores 170. Each of the report processors 175 can produce a portion of one or more final results based on the report segments.

For example, RP_1 can produce a final result portion FRP_1A of the final result based on the report segment RS_1. RP_2 can produce a final result portion FRP_1B of the final result based on the report segment RS_1. RP_Y can produce a final report portion FRP_R of the final result based on the report segment RS_R. The final result can include the individual final result portions FRP_1A, FRP_1B, and FRP_R based on the individual report segments RS_1 and RS_R. The individual or combined final result portions can include a final report, such as a top N determination based on predefined criteria.

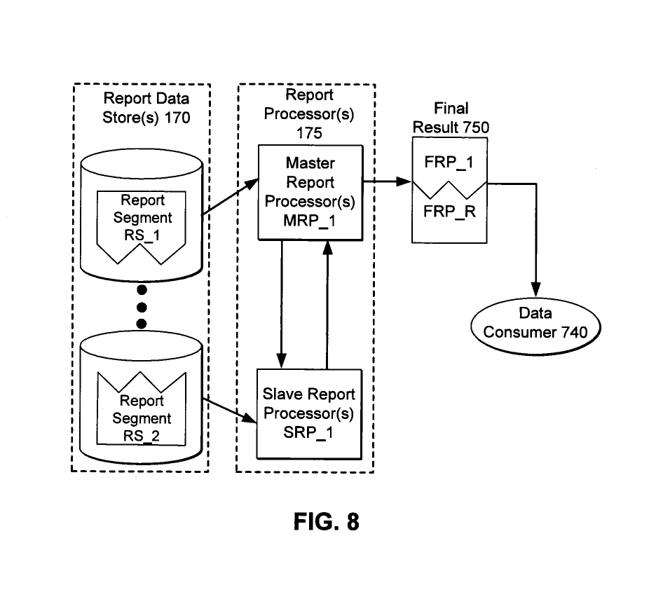

FIG. 7 shows a block diagram including the report processors 175 of FIG. 6 in further relation to the data consumers 705, 710, 720, 730, and 740 according to another example embodiment of the invention. As shown in FIG. 7, the report processors 175, such as RP_1 through RP_Y, can transmit the final result, or portions of the final result, to one or more individual data consumers. In other words, the portions of the final result, such as final result portions FRP_1A, FRP_1B, and FRP_R, can be streamed to individual data consumers 710, 720, and 730, respectively, as multiple portions or multiple streams of data in parallel, or otherwise simultaneously transmitted. Alternatively, the report processor(s) 175 can cooperatively produce a single final result, such as a merged or combined final report 750, which can be transmitted to a data consumer, such as data consumer 740. In yet another embodiment, the portions of the final result, such as final result portions FRP_1A, FRP_1B, and FRP_R, can be streamed over separate physical channels, such as Channels 1, 2, and 3, to a single data consumer 705. This is particularly useful where the final result comprises a large amount of data; the portions of the final result can be transmitted simultaneously over different channels and processed by a single data consumer or multiple data consumers.

Any of the data consumers 705, 710, 720, 730, or 740 can be any external system or end-user. For example, the data consumers 705, 710, 720, 730, or 740 are operable with a computer server, a computer system, an integrated circuit such as an ASIC, software, firmware, or any combination thereof. The data consumers 705, 710, 720, 730, or 740 can also be an individual (i.e., person).

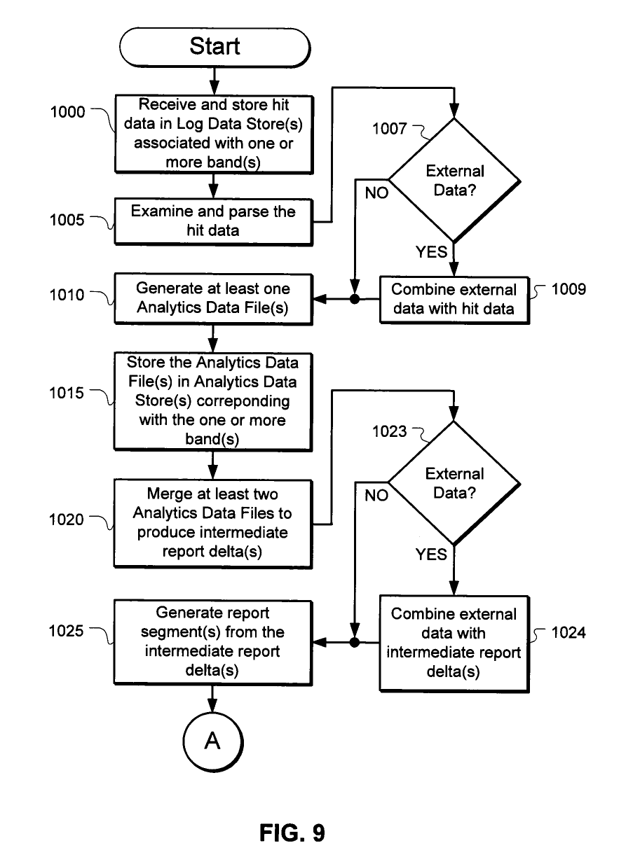

FIG. 8 shows a block diagram including an alternative embodiment of the report data store(s) 170 of FIG. 6, and associated therewith master report processor(s), such as MRP_1, and slave report processor(s), such as SRP_1. One or more slave report processors, such as SRP_1, produce portions of the final result, such as final report portion FRP_R. A master report processor, such as MRP_1 can marshal or otherwise control the slave report processors, such as SRP_1. The master report processor MRP_1 combines a portion of the final result, such as FRP_R, produced by the slave report processor, with another portion of the final result, such as FRP_1, and outputs the final result 750 to data consumer 740. In one embodiment, there is a fixed master report processor MRP_1, and all other report processors are designated as slaves. In another embodiment, there are multiple masters, each having one or more slaves. Master report processors can be dynamically or automatically converted to slave report processors, and visa versa, based on the processing and load conditions of the distributed analytics system.

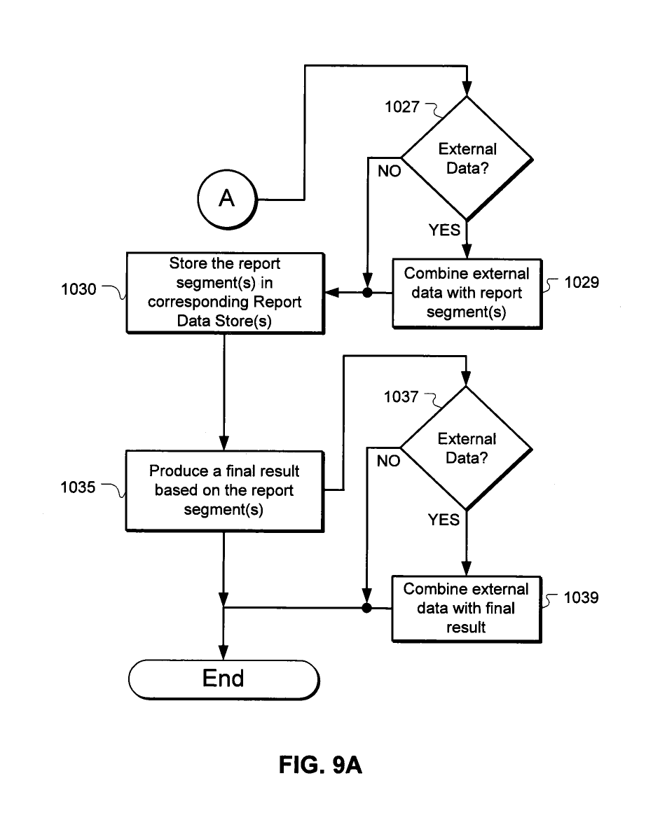

FIGS. 9 and 9A show a flow diagram for receiving, storing, and processing analytics data according to an example embodiment of the invention. At 1000, hit data is received and stored in log data stores associated with one or more bands. The details of how the hit data is partitioned among the bands is described above with reference to FIGS. 3-6, and therefore, need not be repeated. At 1005, log processors can examine and parse the hit data. A determination is made at 1007 whether external data is available and is desirable to be combined with the hit data. If no, the flow proceeds to 1010. If yes, the flow proceeds to 1009, and the external data is combined with the hit data, after which the flow proceeds to 1010, where the analytics generators can generate at least one analytics data file. At 1015, the analytics generators store the analytics data files in analytics data stores corresponding with one or more bands. As previously discussed, the analytics generators can generate new analytics data store files including at least some previously stored historical event data.

The flow then proceeds to 1020 where the analytics generators merge at least two analytics data files to produce intermediate report deltas. A determination is made at 1023 whether external data is available and is desirable to be combined with the intermediate report deltas. If no, the flow proceeds to 1025. If yes, the flow proceeds to 1024, and the external data is combined with the intermediate report deltas, after which the flow proceeds to 1025, where report generators are configured to generate report segments from the intermediate report deltas. The flow then proceeds through A, to FIG. 9A, and a determination is made at 1027 whether external data is available and is desirable to be combined with the report segments. If no, the flow proceeds to 1030. If yes, the flow proceeds to 1029, and the external data is combined with the report segments, after which the flow proceeds to 1030, where the report generators store the report segments in corresponding report data stores.

Thereafter, the flow proceeds to 1035, where report processors produce a final result based on the report segments. A determination is made at 1037 whether external data is available and is desirable to be combined with the final result. If no, the flow ends. If yes, the flow proceeds to 1039, and the external data is combined with the final result, after which the flow ends. The final report can be provided as individual portions to one or more data consumers, or alternatively, as a collective report.

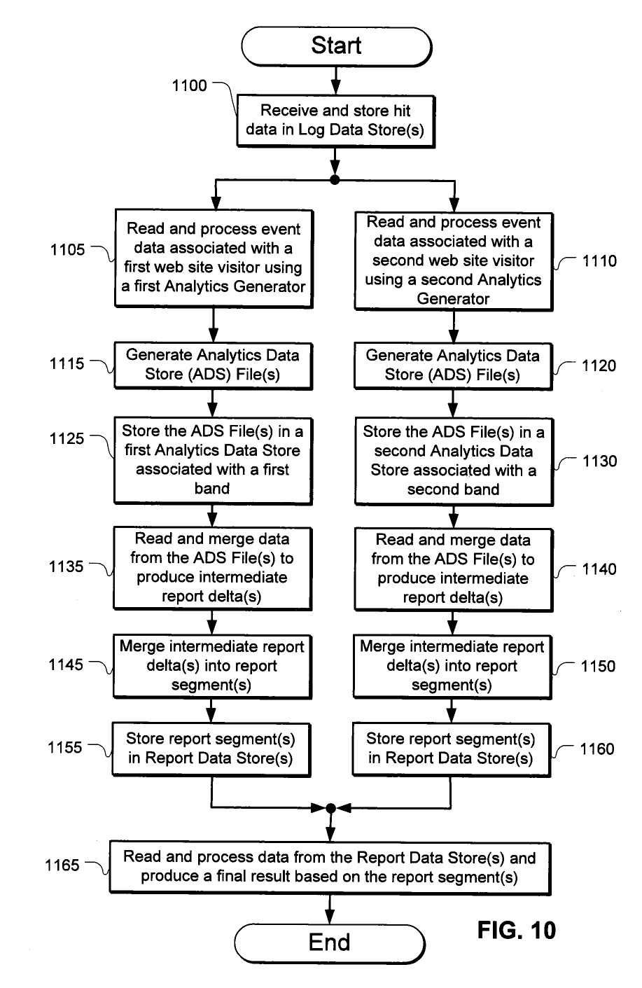

FIG. 10 shows a flow diagram for receiving, storing, and processing analytics data according to another example embodiment of the invention. At 1100, hit data is received and stored in log data stores. At 1105 and 1110, parallel processing occurs such that a first analytics generator reads and processes event data associated with a first web site visitor simultaneously while a second analytics generator reads and processes event data associated with a second web site visitor. The parallel processing proceeds with 1115 and 1120, where analytics data stores are generated by either the first or second analytics generator. At 1125 and 1130, the analytics generators store the respective analytics data store files in analytics data stores associated with either a first or second band. For example, the first analytics generator stores an analytics data store file in a first band, and the second analytics generator store an analytics data store file in a second band. The first web site visitor is associated with the first band and the second web site visitor is associated with the second band.

At 1135 and 1140, analytics processors read and merge data from corresponding analytics data store files to produce intermediate report deltas. The intermediate report deltas are merged into report segments at 1145 and 1150 by report generators. The report generators store the report segments in report data stores at 1155 and 1160. At 1165, report processors read and process data from the report data stores and produce a final result based on the report segments.

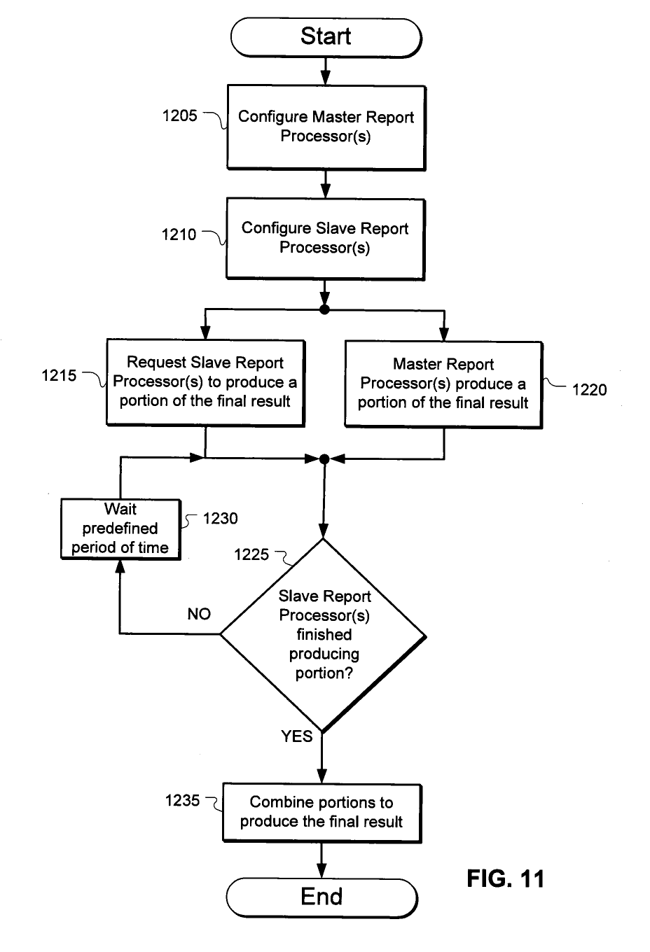

FIG. 11 shows a flow diagram for configuring and processing master report processors and slave report processors for simultaneously processing portions of a final result. It should be understood that any of the elements of the flow diagram can be rearranged and need not be in the specific illustrated order. At 1205, a master report processor is configured. At 1210, a slave report processor is configured. The flow proceeds to 1215 and 1220, where parallel processing between the master and slave report processors occurs. Specifically, at 1215, a slave report processor is requested to produce a portion of the final result. At 1220, a master report processor produces a portion of the final result. A determination is made at 1225 whether the slave report processor has finished producing its portion of the final result. If no, the flow waits for a predefined period of time at 1230 and then makes the determination again at 1225. If yes, the flow proceeds to 1235, where the portions of the final result are combined to produce the final result. As previously discussed, an alternative embodiment includes transmitting individual portions of the final results to one or more consumers, which can then be simultaneously processed.

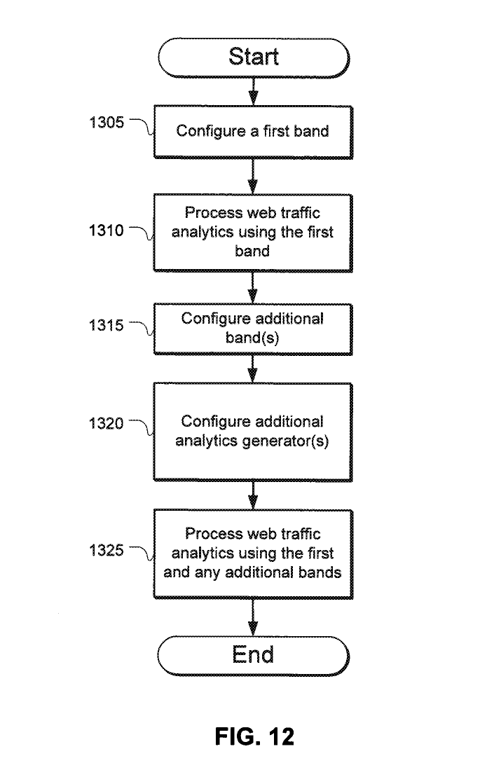

FIG. 12 shows a flow diagram for configuring first and second bands, and processing web traffic analytics data using the first and second bands. At 1305, a first band is configured. At 1310, web traffic analytics are processed using the first band. For example, a web server owner/operator may launch a new website using the first band to process web traffic analytics data. Eventually, the traffic load from visitors to the web site will increase. The one band may now be insufficient to process the increased load. For example, at 1315, a second band is configured.

Preferably, the first band is configured on a first web server and the second band is configured on a second web server, although this need not be the case. More than one band can be configured to operate on a single web server. As previously explained, a “band” is essentially a storage partition and/or associated processing of a predefined group of data based on predefined criteria. In other words, a range of data can be assigned to a given band, and any mechanism can be used to separate the data among the bands; preferably, a partition key is used to determine which band receives which data.

The number of bands in the analytics system can be either increased or decreased, which is referred to as “re-banding.” Re-banding improves the distribution of analytics data processing across the bands. If additional bands are added, then additional analytics generators 150 can be instantiated, or otherwise configured, so that the hit data or parsed data can be further distributed among the increased number of bands. Once analytics generators are added, each of the analytics generators 150 can be reconfigured to process a different range of hit data or parsed data. Information or data that is already present in the previously defined bands need not be copied or moved to another band to achieve re-banding. Rather, the information or data associated with the previously defined bands can remain in place, and the newly configured analytics generators 150 can be assigned to process data associated with the newly configured bands.

For example, at 1320, a new analytics generator 150 is configured to process information or data associated with the new band configured at 1315. Thereafter, web traffic analytics can be processed using the first and second bands, as shown at 1325. As another example, consider an analytics system that originally comprises two bands and two analytics generators. Subsequently, two additional bands are configured at 1315, and two additional analytics generators are configured at 1320, for a total of four bands and four analytics generators. Thereafter, each of the four analytics generators can process approximately one fourth of the hit data or parsed data, thereby further distributing the processing and storing of the data.

In addition to expanding the number of bands, the number bands can also be reduced. For example, if bands are removed, then corresponding analytics generators 150 can also be removed, or otherwise de-configured, and the second band can be decommissioned or removed from the distributed analytics system. In this scenario, the web traffics data stored in the band to be removed can be redistributed to a different band, and each of the remaining analytics generators 150 can be reconfigured to process a different range of hit data or parsed data.

It should be understood that any of the elements of any of the flow diagrams described above can be rearranged and need not be in the specific illustrated order.

It should also be understood that the term “individual” or “visitor” as used herein can refer to an individual person, and such terms can generally be interchangeable in their meaning. Nevertheless, an “individual” need not be a “visitor” per se. Information about individuals such as sales forces, company personnel, or citizens of a state or country, can be processed using the inventive concepts disclosed herein without the individuals ever visiting a website.

In addition, a visitor can refer to an individual that visits a website, for example, or a machine that visits a website. A visitor can also refer to a software application, such as a web-bot or automated algorithm, among other possibilities. While some embodiments of the present invention are directed to web-traffic analytics, the embodiments are not limited thereto. For instance, the analytics generators, or other components described herein, can read and process any data associated with any number of individuals or visitors. Such data can include marketing data, product user data, sales statistics, lead generation, citizenry data, or any other suitable digitized data.

The following describes further examples of how the distributed analytics system can be used under different scenarios. Ten (10) analytics generators and ten (10) analytics data stores and corresponding bands can be configured, one analytics generator for each band. Each analytics generator processes one hour of parsed hit data, from a batch of multiple hours of parsed hit data. The parsed hit data can be sequentially ordered by time. Each analytics generator reads hit data from the current batch, and groups them first by visitor IDs, and then by visitor ID within each visitor ID. For each visitor ID having a hit associated therewith, the corresponding analytics generator can check whether this visitor ID had a hit within the last 60 days, or within some other specified history parameter. If there is a hit, the analytics generator can process all hits for this visitor ID from the most recent historical ADS file, and generate a new ADS file including the current hits and historic hits. Each analytics generator can then process the next hour of hit data from the batch, and if none are available, then wait a predefined period of time.

Ten (10) analytics processors can be configured, one for each band. Each analytics processor reads and processes ADS files as they become available. ADS files that are waiting to be processed can be maintained in a queue. Each analytics processor can read the current hit data from an ADS file. Optionally, the analytics processors can ignore the historical data from the same ADS file. Moreover, each analytics processor can maintain counts corresponding to a frequency of detection of different hit data or event attributes, as previously described, and partition or merge the data into intermediate results, such as intermediate report deltas. The intermediate report deltas are transmitted to one or more report generators.

Each report generator can wait to receive one of the intermediate report deltas from one of the analytics processors. The report generators can perform further processing of the counts corresponding to the frequency of detection of different hit data or event attributes, and store the results as report segments in the report data stores.

Consider the scenario of generating and storing report segments. If a web server operator desired to know the top-pages, or the most frequently visited pages of a web site, the report generators could generate and store two report segments, one report segment for any web page within the domain *.products.xyz.com, for example, and another report segment for all other web pages of the web site. The * symbol is a wildcard and can represent any page within the specified domain. In this scenario, two (2) instances of the report generators and two (2) instances of the report data stores are configured to process and store the two report segments.

It should be understood that various arrangements and combinations of the disclosed elements of the distributed analytics system can be structured to produce similar results, and the inventive aspects are not limited to the particular and specific illustrated arrangements. For example, each of the ten (10) analytics data stores and corresponding bands can be configured to operate on ten (10) distinct web servers, respectively. Similarly, the two (2) report generators and the two (2) report data stores can be configured to operation on two (2) distinct web servers, respectively. In this scenario, 12 distinct web servers would be configured as part of the distributed analytics system. It should be understood that other configurations are contemplated, and the inventive aspects are therefore not to be limited to any one configuration.

As another example, the analytics generators and analytics processors can be configured to operate on the web server where the application data stores and corresponding bands reside. Similarly, the report generators and report processors can be configured to operate on the web server where the corresponding report data stores reside.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciated that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having illustrated and described the principles of our invention in a preferred embodiment thereof, it should be readily apparent to those skilled in the art that the invention can be modified in arrangement and detail without departing from such principles. We claim all modifications coming within the spirit and scope of the accompanying claims.

We claim:

1. A method for distributed processing of analytics data, comprising:
generating a plurality of analytics data store files, each analytics data store file including analytics information corresponding to a predefined period of time and stored in one of a plurality of bands;
configuring a plurality of analytics generators, each analytics generator being associated with one of the plurality of bands;
a first analytics generator reading and processing event data associated with a first individual; and
a second analytics generator reading and processing event data associated with a second individual,
wherein the first individual is associated with one of the plurality of bands, and the second individual is associated with another of the plurality of bands.

2. The method of claim 1, further comprising:
the first analytics generator reading historical event data from a recent historical analytics data store file associated with the first individual, and generating a first new analytics data store file including at least some of the associated event data and historical event data; and
the second analytics generator reading historical event data from a recent historical analytics data store file associated with the second individual, and generating a second new analytics data store file including at least some of the associated event data and historical event data.

3. The method of claim 2, wherein the first new analytics data store file is stored in one of the plurality of bands, and the second new analytics data store file is stored in another of the plurality of bands.

4. The method of claim 2, further comprising:
configuring a plurality of analytics processors, each of the plurality of bands being associated with one or more of the analytics processors; and
each of the analytics processors reading and merging data from one or more of the analytics data store files, and producing one or more intermediate report deltas.

5. The method of claim 4, further comprising:
configuring a plurality of report generators, the report generators receiving the one or more intermediate report deltas.

6. The method of claim 5, further comprising:
outputting data from the one or more intermediate report deltas to one or more data consumers.

7. The method of claim 5, further comprising:
merging data from the one or more intermediate report deltas into one or more report segments; and
storing the one or more report segments in corresponding one or more report data stores.

8. The method of claim 7, further comprising:
configuring a plurality of report processors, each report processor reading data from the one or more report data stores and producing a final result based on the report segments.

9. The method of claim 8, wherein the final result is based on at least two merged report segments.

10. The method of claim 8, wherein the final result is based on individual report segments.

11. The method of claim 8, wherein the final result includes a top N determination based on predefined criteria.

12. The method of claim 8, further comprising:
the report processors transmitting the final result to one or more data consumers.

13. The method of claim 8, further comprising:
a slave report processor producing a portion of the final result; and
a master report processor marshaling the slave report processor, combining the portion of the final result produced by the slave report processor with another portion of the final result, and outputting the final result.

14. The method of claim 1, further comprising:
combining external data with the event data associated with the first individual or the second individual.

15. The method of claim 4, further comprising:
combining external data with data from one or more of the analytics data store files, and producing the one or more intermediate report deltas based in part on the external data.

16. The method of claim 8, further comprising:
combining external data with data from the one or more report data stores and producing the final result based in part on the external data.

17. A web-traffic analytics device, comprising:
an analytics generator configured to read event data associated with a web site visitor, and to store the event data in an analytics data store associated with a band;
an analytics processor associated with the band, the analytics processor being configured to read and merge data from the analytics data store, and to produce an intermediate report delta;
a report generator configured to receive the intermediate report delta from the analytics processor, and to partition data from the intermediate report delta into one or more report segments;
a report data store to store the one or more report segments; and
a report processor to read data from the report data store and to produce a final result based on the one or more report segments.

18. The web-traffic analytics device of claim 17, further comprising:
a log data store to receive hit data and to store the hit data in the band; and
a log processor to examine the hit data, and to parse a visitor identification (ID) and associated event attributes, wherein the analytics generator is configured to receive the visitor ID and the event attributes from the log processor and generate the analytics data store associated with the band.

19. A distributed analytics system, comprising:
a log data store to receive one or more hits and to store the one or more hits in one or more first bands, wherein each hit represents activities of a visitor on a web site;
one or more log processors to examine each hit within the one or more first bands, and to parse a visitor identification (ID) and associated plurality of event attributes; and
one or more analytics generators to receive the visitor ID and the plurality of event attributes from the one or more log processors, and to generate at least one analytics data file to be stored in one or more second bands,
wherein each of the second bands is associated with a corresponding one of the first bands.

20. The distributed analytics system of claim 19, wherein each of the bands is associated with one computer server.

21. The distributed analytics system of claim 19, wherein the one or more first bands is associated with a first computer server, and the one or more second bands is associated with a second computer server.

22. The distributed analytics system of claim 19, wherein a visitor is assigned to the one or more first bands based on a function of (visitor ID modulo L), where L is the number of first bands.

23. The distributed analytics system of claim 19, wherein a visitor is assigned to the one or more first bands based on a function of geographic location of the visitor.

24. The distributed analytics system of claim 23, further comprising:
one or more analytics data stores to store the at least one analytics data file in the one or more second bands; and
one or more analytics processors to merge the at least one analytics data file with at least one second analytics data file and to produce an intermediate report delta.

25. The distributed analytics system of claim 24, wherein more than one analytics processor is associated with a single one of the second bands.

26. The distributed analytics system of claim 24, further comprising:
one or more report generators operatively associated with the one or more analytics processors, the one or more report generators configured to receive the intermediate report delta.

27. The distributed analytics system of claim 26, wherein the one or more report generators is configured to output data from the intermediate report delta to one or more data consumers.

28. The distributed analytics system of claim 26, wherein the one or more report generators is configured to merge data from the intermediate report delta into one or more report segments.

29. The distributed analytics system of claim 28, further comprising:
one or more report data stores associated with the one or more report segments.

30. The distributed analytics system of claim 29, further comprising:
one or more report processors for producing a final result based on the report segments.

31. The distributed analytics system of claim 30, wherein more than one report processor is associated with a single one of the report data stores.

32. The distributed analytics system of claim 30, wherein the final result comprises a single combined final result based on at least two merged report segments.

33. The distributed analytics system of claim 30, wherein:
the final result comprises individual portions of the final result that are based on individual report segments; and
each of the report processors is configured to transmit a corresponding portion of the final result to a data consumer over an individual channel.

34. The distributed analytics system of claim 30, wherein the one or more report processors is configured to transmit the final result to one or more data consumers.

35. The distributed analytics system of claim 30, wherein the one or more report processors comprise:
a slave report processor to produce a portion of the final result; and
a master report processor configured to marshal the slave report processor, to combine the portion of the final result produced by the slave report processor with another portion of the final result, and to output the final result.

36. A method for redistributing analytics data in a distributed analytics system, comprising:
configuring a first band for storing web traffic analytics data;
processing the web traffic analytics data using the first band;
configuring a second band in the distributed analytics system; and
processing the web traffic analytics data using the first and second bands.

37. The method of claim 36, further comprising:
instantiating a first analytics generator to process the web traffic analytics data when the first band is configured; and
after configuring the second band, instantiating a second analytics generator to process a range of the web traffic analytics data, and configuring the first analytics generator to process a different range of the web traffic analytics data.

38. The method of claim 36, further comprising:
redistributing all of the web traffic analytics data stored in the second band to the first band; and
removing the second band from the distributed analytics system.

39. The method of claim 36, wherein the first band is associated with a first computer server and the second band is associated with a second different computer server.
